(19) United States
(12) Patent Application Publication
(10) Pub. No.: US 2025/0045807 A1
(43) Pub. Date: Feb. 6, 2025

(54) IN-APPLICATION TRANSACTION INTERFACE

(71) Applicant: MASTERCARD INTERNATIONAL INCORPORATED, Purchase, NY (US)

(72) Inventors: Greg White, Tuckahoe, NY (US); Jason Kocherhans, Vineyard, UT (US)

(21) Appl. No.: 18/794,210

(22) Filed: Aug. 5, 2024

Related U.S. Application Data
(60) Provisional application No. 63/530,771, filed on Aug. 4, 2023.

(51) Int. Cl. G06Q 30/04; G06Q 20/14

(52) U.S. Cl. CPC G06Q 30/04; G06Q 20/14

(57) ABSTRACT

A method can include providing a bill detail for a bank-as-biller account within a graphical user interface of a banking application, wherein the bank-as-biller account has a biller identifier for electronic payment and an open banking identifier; establishing a connection with the bank-as-biller account using the open banking identifier; receiving a request to view transaction detail history for the bank-as-biller account; and in response to the request to view transaction detail history for the bank-as-biller account: calling a first open banking application programming interface (API) over the established connection with the bank-as-biller account to obtain the transaction detail history for the bank-as-biller account; receiving the transaction detail history; and generating a transaction history view using the received transaction detail history. The method can further include, after performing payment operations, confirming payment to the bank-as-biller account is reflected in a balance for the bank-as-biller account using the open banking identifier.

### BACKGROUND

Banking applications can provide an online bill-pay opportunity. In some cases, the financial institution associated with the banking application can directly transfer funds (e.g., to a payee account) through a payment or banking rail. In other cases, the financial institution may mail a physical check to the payee. However, the information available within a user's banking application for online bill-pay tends to be limited. The exception to this limited information is with respect to an account directly managed by the financial institution through which the banking application is associated. For example, transaction details are available for a payment card account issued by the financial institution within the banking application. Similarly, when a payment has been made to the payment card account issued by the financial institution, the total balance is updated and able to be viewed by the card holder within the banking application.

### BRIEF SUMMARY

An in-application transaction interface is provided that enables a consumer to receive bill content through bill pay open banking. Through the described systems and methods, it is possible to include bill content in a banking application of a first financial institution for bill types including credit card, mortgage, home equity loan and auto loan bills through other financial institutions.

In some aspects, the techniques described herein relate to a method including: providing a bill detail for a bank-as-biller account within a graphical user interface of a banking application, wherein the bank-as-biller account has a biller identifier for electronic payment to the bank-as-biller account and an open banking identifier associated with the bank-as-biller account; establishing a connection with the bank-as-biller account using the open banking identifier; receiving a request to view transaction detail history for the bank-as-biller account; and in response to the request to view transaction detail history for the bank-as-biller account: calling a first open banking application programming interface (API) over the established connection with the bank-as-biller account to obtain the transaction detail history for the bank-as-biller account; receiving the transaction detail history; and generating a transaction history view using the received transaction detail history.

In some aspects, the techniques described herein relate to a method, further including: receiving a payment request to effect payment for the bank-as-biller account; performing a first electronic payment using the biller identifier associated with the bank-as-biller account to effect the payment for the bank-as-biller account; confirming payment to the bank-as-biller account is reflected in a balance for the bank-as-biller account using the open banking identifier for the bank-as-biller account; and generating a confirmation transaction view for displaying updated account information of the bank-as-biller account that reflects the application of the payment to the bank-as-biller account by the bank-as-biller account.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an operating environment of an in-application transaction interface.

FIGS. 2A-2E illustrate a transaction detail display and payment flow utilizing an in-application transaction interface.

FIGS. 3A and 3B illustrate process flow diagrams of methods of operating an in-application transaction interface for the transaction detail display and payment flow shown in FIGS. 2A-2E.

FIGS. 4A-4D illustrates an example consent process for a bank as a biller in a banking application.

FIG. 5 illustrates a block diagram illustrating components of a computing device used in some embodiments.

### DETAILED DESCRIPTION

An in-application transaction interface is provided that enables a consumer to receive bill content through bill pay open banking. Through the described systems and methods, it is possible to include bill content in a banking application of a first financial institution for bill types including credit card, mortgage, home equity loan and auto loan bills through other financial institutions.

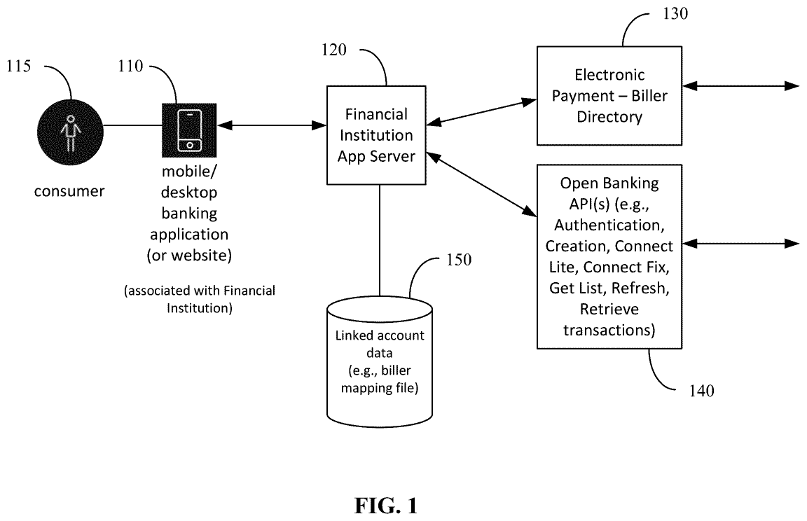

FIG. 1 illustrates an operating environment of an in-application transaction interface. Referring to FIG. 1, a banking application executed on a mobile device or desktop computer 110 can include an in-application transaction interface supporting bill content and transaction-level details for bills associated with other financial institutions that a consumer 115 has accounts with. For example, the described interface is useful for credit cards, lines of credit, mortgages, loans, and auto loans, as some examples. The banking application leverages electronic payment functionality and open banking functionality to enable an in-application transaction interface.

For example, the banking application (directly at the mobile device or desktop computer 110 or via a financial institution application server 120 that supports the banking application) accesses two data streams-open banking API(s) 140 and electronic payment biller directory 130 to obtain bill and account content of another financial institution as well as effect payment towards that bill and/or account. The electronic payment biller directory 130 can be the remote payment and presentment service (RPPS) provided by MASTERCARD. The open banking APIs 140 can include 7 APIs (described in detail herein) to authenticate a Payer and pull required bill content. In some cases, the open banking APIs 140 are supported by the FINICITY open banking platform.

Since the two types of data streams (electronic payment and open banking) access separate systems, a linked account data file is generated and provided to the financial institution application server 120 so that actions with respect to the open banking API(s) 140 can be mapped to entities available through the electronic payment biller directory 130. This linked account data file can be a Biller Mapping file, which contains a list of Biller identifiers (IDs) available through the electronic payment biller directory 130, each with an associated open banking identifier. The linked account data file can be stored in a data storage resource 150 that is accessible by or associated with the financial institution application server 120.

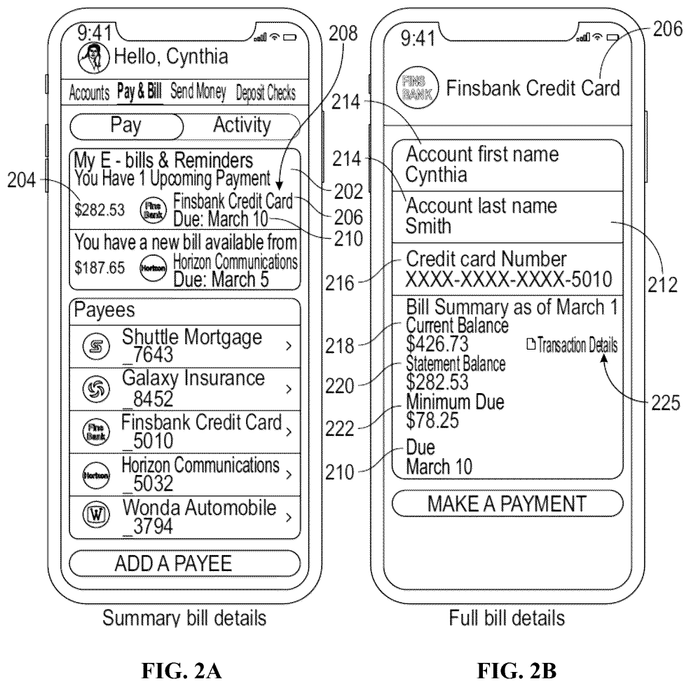

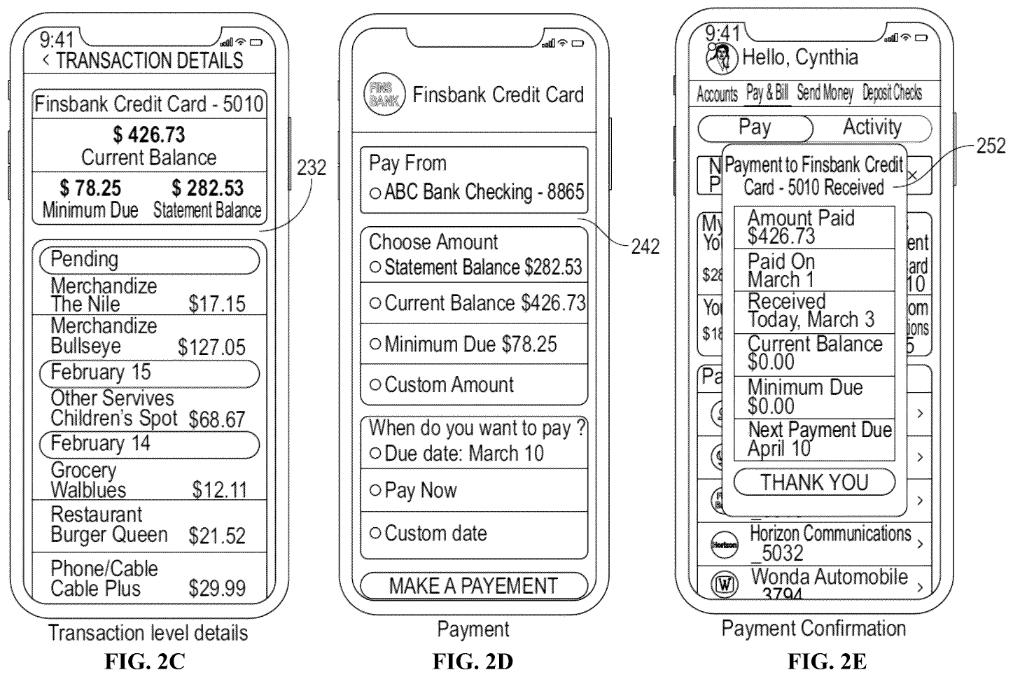

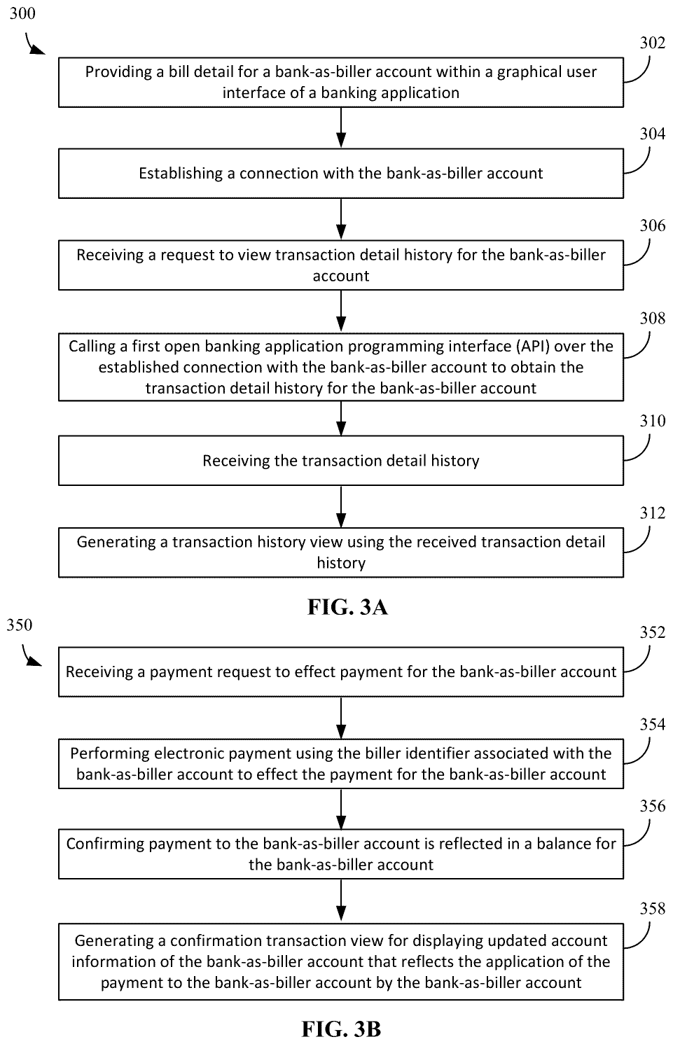

FIGS. 2A-2E illustrate a transaction detail display and payment flow utilizing an in-application transaction interface; and FIGS. 3A and 3B illustrate process flow diagrams of methods of operating an in-application transaction interface for the transaction detail display and payment flow shown in FIGS. 2A-2E. Conventionally, a user can select a payee displayed in a banking application graphical user interface and view the general details (in summary or longer form) of an e-bill from within the banking application. For example, referring to FIG. 2A, in the first screen 202, a bill detail (e.g., amount due 204) for a bank-as-biller account (e.g., Finsbank Credit Card 206) is shown within a graphical user interface of a banking application. In the example illustration, the summary bill details 208 of an e-bill includes the name of the payee (Finsbank Credit Card 206), amount due 204 ($282.53), and due date 210 (Mar. 10). As with a variety of banking applications, the example view for paying a bill shown in the first screen 202 includes a listing of payees, including a summary bill detail for e-bills set up with the financial institution associated with the banking application.

Referring to FIG. 2B, as illustrated in the second screen 212, a longer form of the general details of the e-bill for the payee (e.g., Finsbank Credit Card 206) can be displayed. These general details often include payer/account holder name (e.g., first and last name 214), account identifier of the payer to the payee (e.g., credit card number/last four digits of the credit card number 216), current balance 218, statement balance 220, minimum due 222, and due date 210.

However, unlike conventional bill payment interfaces, the banking application can present timely transaction detail history associated with a bank-as-biller account using the described in-application transaction interface. For example, as also shown in the second screen, an icon 225 for transaction details is presented, indicating that transaction details can be obtained by the banking application. In some cases, interaction with icon 225 can initiate the steps of obtaining and providing for display the transaction detail history associated with the bank-as-biller account, as described with respect to FIG. 3A.

With reference to FIG. 3A, a method 300 of operating an in-application transaction interface can include providing (302) a bill detail for a bank-as-biller account within a graphical user interface of a banking application, for example, as illustrated in the first screen 202 and/or second screen 212. At some point in time, the banking application can establish (304) a connection with the bank-as-biller account using an open banking identifier associated with the bank-as-biller account. The banking application can receive (306) a request to view the transaction detail history (e.g., by selection of the payer to view the transaction details); call (308) the open banking API over the established connection with the bank-as-biller account; receive (310) the transaction detail history; and generate (312) a transaction history view using the received transaction detail history. The transaction history view can be displayed in the graphical user interface of the banking application.

In some cases, establishing (304) the connection with the bank-as-biller account includes performing authentication, registration, and connection with a financial institution of the bank-as-biller account using one or more APIs. For example, the Partner Authentication API, Creating an Active Customer API, and Connect Lite API open banking APIs described in more detail herein may be used.

The open banking API used in the calling (306) step can be a first open banking API that gets a specified customer's account transactions associated with a specified bank-as-biller-account identified by the open banking identifier, for example, as described with respect to the open banking API “Get Customer Account Transactions API” or the “Refresh Customer Accounts API”.

An example of a displayed transaction history view is shown in the third screen 232 of FIG. 2C. As mentioned above, the described interface is useful for credit cards, lines of credit, mortgages, loans, and auto loans from other institutions, as some examples. Different types of accounts can utilize different data usage (e.g., the information useful for a mortgage and loan can include some different pieces of data than a credit card and line of credit). Thus, the banking application can generate different transaction history views (with different data) depending on the type of account. In some cases, the transaction history views reflect the types of information available from bill content.

Although not shown in the example graphical user interface in FIG. 2C, as with the full bill details view for making a payment shown in the second screen, a button for invoking the make payment command can be presented in a transaction level details view (the “transaction view”) of the third screen 232.

Once a payer selects to make a payment, a payment screen, such as the example shown in the fourth screen 242 of FIG. 2D, can be displayed and payment can be made by the banking application.

Advantageously, not only are the transaction level details available within the banking application, through the described in-application transaction interface, a payer is able to confirm that payment has been received and applied to the account. Indeed, instead of only being able to confirm that payment has been sent, it is possible to confirm that payment is received and applied to the account. For example, as shown in the fifth screen 252 of FIG. 2E, the banking application can display that the payment was received along with the updated balance for that account as part of a confirmation transaction view. The banking application is able to provide this information through calling one of the open banking APIs. For example, updated information can be pulled at regular intervals (such as once per 24 hours or some other time frame) using one of the open banking APIs. In some cases, the responses to the API calls can indicate the freshness of the data for the account information.

For example, turning to FIG. 3B, method 350 can include receiving (352) a payment request to effect payment for the bank-as-biller account; performing (354) a first electronic payment using the biller identifier associated with the bank-as-biller account to effect the payment for the bank-as-biller account; confirming (356) payment to the bank-as-biller account is reflected in a balance for the bank-as-biller account using the established connection with the bank-as-biller account; and generating (358) a confirmation transaction view for displaying updated account information of the bank-as-biller account that reflects the application of the payment to the bank-as-biller account by the bank-as-biller account.

Confirming (356) that the payment to the bank-as-biller account is reflected in the balance for the bank-as-biller account can include calling a second open banking API over the established connection with the bank-as-biller account to obtain updated information including a balance due and an account balance. The second open banking API can be an API that gets updated customer account information such as the balance due and the account balance. The second open banking API can be called at predetermined intervals, periodically, or in response to some trigger (which may be related to a user's activity, timing, etc.).

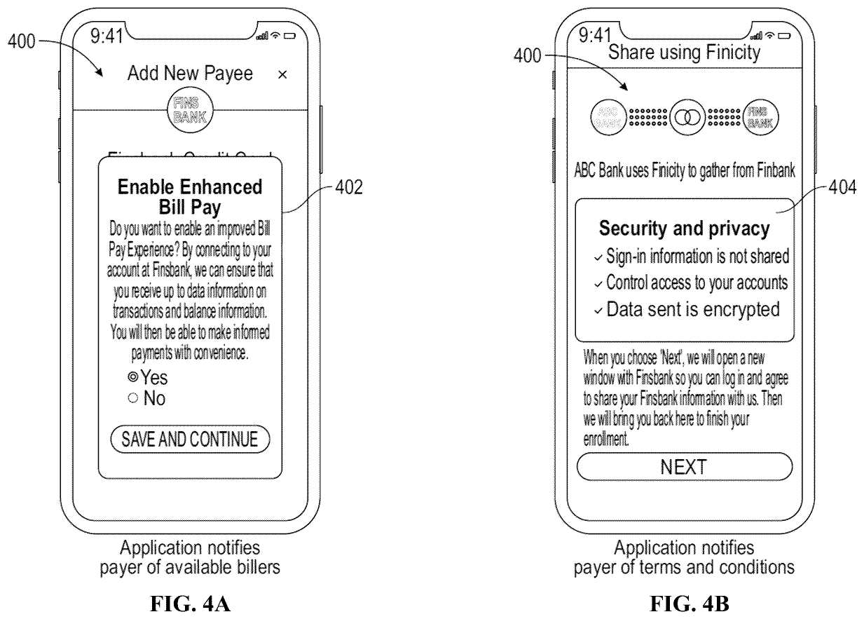

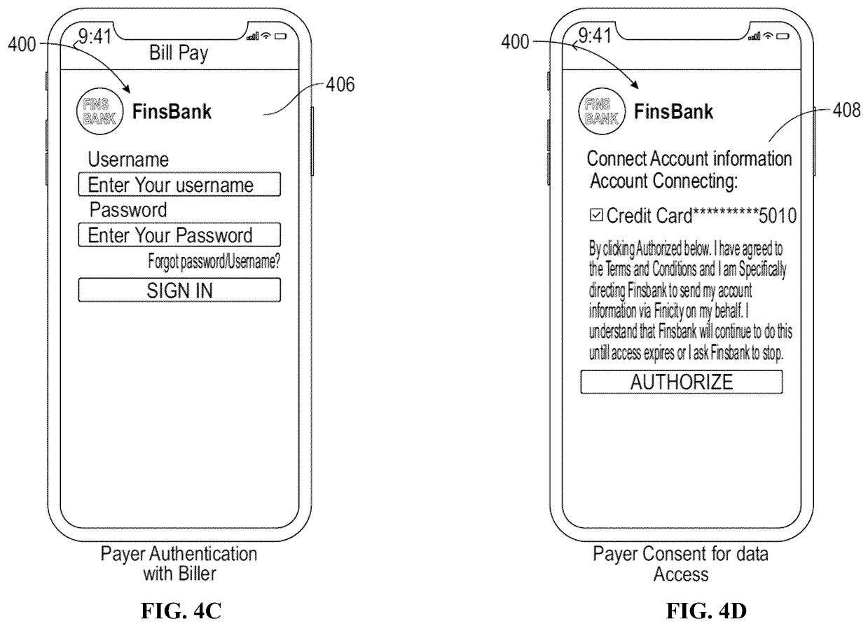

FIGS. 4A-4D illustrate an example consent process for a bank as a biller in a banking application. Referring to FIG. 4A, similar to adding a new payee, a bank as a biller (“bank-as-biller”) can be set up as a payee in the banking application for the electronic payment service.

The financial institution application server checks the linked account data file to determine whether the bank-as-biller has an associated open banking identifier. If the bank-as-biller is determined to have the associated open banking identifier, the banking application can notify the payer that the bill content is available to the payee. For example, the banking application can present an option to receive bill content (e.g., in the graphical user interface). As illustrated in the first screen 402 of the graphical user interface 400, the banking application notifies the payer that bill content is available for a biller.

The payer can select to receive bill content (and accept terms and conditions), for example, by interacting with the graphical user interface of the banking application. The banking application can, in response to receiving the selection by the payer, direct steps to authenticate the payer with the bank-as-biller (e.g., via the open banking API). In addition, the banking application communicates, via the open banking API, the payer's permission to receive the data. For example, referring to FIG. 4B, as illustrated in the second screen 404, terms and conditions can be displayed with a button for the user to interact with for accepting the terms and conditions, as well as other functions for reviewing the information. As illustrated in the third screen 406 shown in FIG. 4C, the payer can enter information, which is sent by the banking application to the biller via one of the open banking APIs for authenticating the payer's credentials with the Biller. As illustrated in the fourth screen 408 shown in FIG. 4D, a graphical user interface displays a screen for the payer to provide consent for the financial institution/banking application to have access to the data.

With this set-up, the banking application establishes a connection with the bank-as-biller-account and can obtain and display bill content and other transaction information to the payer in the graphical user interface. In addition, as explained with respect to FIGS. 2B-2D, the banking application can further include a payment command in the graphical user interface such that in response to receiving a selection of the payment command, the banking application can identify the appropriate biller identifier and effect payment.

In a specific implementation supporting the scenarios of FIGS. 2A-2E, FIG. 3A, FIG. 3B, and FIGS. 4A-4B, the following 7 APIs can be used. For example, for the scenarios illustrated in FIGS. 2A-2E and FIGS. 4A-4D and methods of FIGS. 3A and 3B, authenticate, register, and connect APIs of the open banking APIs can be used.

Partner Authentication API—Once a financial institution associated with the banking application has enrolled in Bill Pay Open Banking Service and established connectivity, the financial institution can start adding real Payer data to its application. The financial institution authenticates with Bill Pay Open Banking Service by calling the ‘Partner Authentication’ API. This API can run every time the financial institution's token expires; of course, other triggers for refreshing tokens can be used.

Creating an Active Customer API—the financial institution (e.g., through the financial institution application server) registers its Payer by calling the ‘Creating an Active Customer’ API. The financial institution completes this call for each Payer. This API creates a customer ID which is linked to all account data. A connect fix API can be available to reauthenticate a Payer with a Biller if there is an issue with matching the account information. It can also be possible to link multiple accounts at a biller so long as a customer provides each account number. A delete customer API can also be available to delete a particular payer.

Connect Lite API—this service can be used by the financial institution to link its Payer to the Biller. The financial institution (e.g., through the financial institution application server) can call the ‘Connect Lite’ API, which returns a URL link that the financial institution can use to implement ‘Connect Lite’ in its own web or mobile applications. The Payer can leverage ‘Connect Lite’ to authenticate with the Biller and give permission for the DI to access data. A Payer goes through this process with each biller. If a Payer has multiple accounts with a biller, they can authenticate with multiple accounts through one request. At the end of this process an authentication token will be generated, and this will be used to pull the Payer data going forward. A ‘Delete Account API’ can be used to delete a linked account.

‘Connect Fix’ API—‘Connect Fix’ API provides a flow for customers to re-authenticate to their accounts when the connection to the user's financial institution is lost. The connection to the Payer's accounts can stop working if the account password has changed or the token provided by the financial institution has been revoked.

For the scenario of FIGS. 2A-2E, get data APIs of the open banking APIs can be used.

Get Customer Accounts API—financial institutions can pull updated information daily (or some other regular occasions), on each linked account, by calling the ‘Get Customer Accounts’ API. Financial institutions can decide how often they want to receive updated account data by calling this API. For example, the financial institution may pull the data once every bill cycle. The financial institution can monitor the ‘Due Date’ of a bill every day, and when the ‘Due Date’ changes, notify the Payer that they are in a new billing cycle. Once a Payer has linked to an account at a biller, Bill Pay Open Banking Service can pull data from the biller, for example, on a nightly basis.

Refresh Customer Accounts API—A financial institution can call the ‘Refresh Customer Accounts’ API to have account information available immediately after linking (near real-time). This API retrieves refreshed data from the biller.

Get Customer Account Transactions API—this API enables the financial institution to pull all transactions on a customer's account.

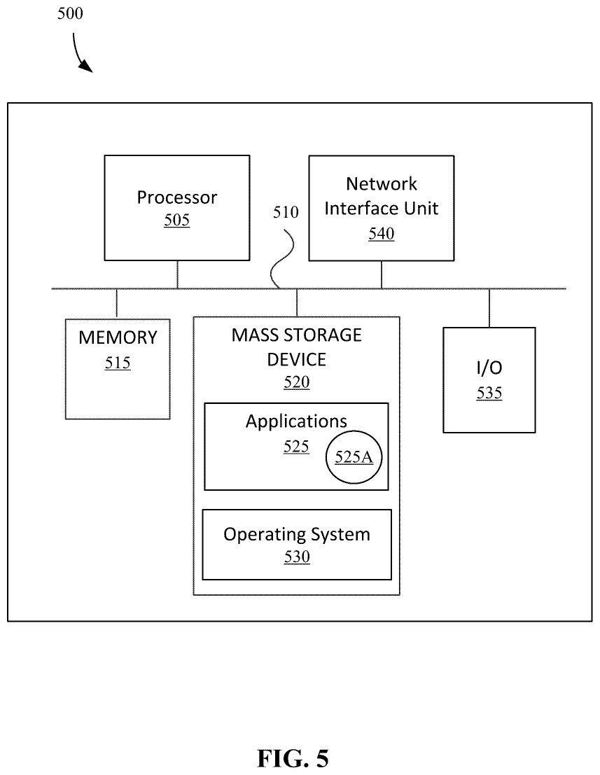

FIG. 5 illustrates a block diagram illustrating components of a computing device used in some embodiments. It should be understood that aspects of the system described herein are applicable to both mobile and traditional desktop computers, as well as server computers and other computer systems. Components of computing device 500 may represent a personal computer, a reader, a mobile device, a personal digital assistant, a wearable computer, a smart phone, a tablet, a laptop computer (notebook or netbook), a gaming device or console, an entertainment device, a hybrid computer, a desktop computer, a smart television, an electronic whiteboard or large form-factor touchscreen, or a server, as some examples. Accordingly, more or fewer elements described with respect to computing device 500 may be incorporated to implement a particular computing device.

Referring to FIG. 5, a computing device 500 can include at least one processor 505 connected to components via a system bus 510; a system memory 515 and a mass storage device 520. A processor 505 processes data according to instructions of one or more application programs 525, and/or operating system 530. Examples of processor 505 include general purpose central processing units (CPUs), graphics processing units (GPUs), field programmable gate arrays (FPGAs), application specific processors, and logic devices, as well as any other type of processing device, combinations, or variations thereof. Processor 505 may be, or is included in, a system-on-chip (SoC) along with one or more other components such as sensors (e.g., magnetometer, an ambient light sensor, a proximity sensor, an accelerometer, a gyroscope, a Global Positioning System sensor, temperature sensor, shock sensor) and network connectivity components (e.g., including network interface 540).

The one or more application programs 525 may be loaded into the mass storage device 520 and run on or in association with the operating system 530. For example, a banking application 525A with in-application transaction interface functionality as described herein can also be stored on the mass storage device 520. Banking application 525A may include instructions to perform methods 300 and 350.

Certain functionality and data can be made available to the banking application 525A via the network interface 540.

It can be understood that the mass storage device 520 may involve one or more memory components including integrated and removable memory components and that one or more of the memory components can store an operating system. Examples of mass storage device 520 include removable and non-removable storage media including random access memory, read only memory, magnetic disks, optical disks, CDs, DVDs, flash memory, magnetic cassettes, magnetic tape, magnetic disk storage or other magnetic storage devices, or any other suitable storage media. Mass storage device 520 (which may also be referred to as a computer readable storage medium/media) does not consist of propagating signals or carrier waves.

The system memory 515 may include a random-access memory (“RAM”) and/or a read-only memory (“ROM”). The RAM generally provides a local storage and/or cache during processor operations and the ROM generally stores the basic routines that help to transfer information between elements within the computer architecture such as during startup. RAM and ROM may also be considered computer readable storage media (and do not consist of propagating signals or carrier waves).

The system can further include user interface system 535, which may include input/output (I/O) devices and components that enable communication between a user and the computing device 500. User interface system 535 can include one or more input devices such as, but not limited to, a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input.

The user interface system 535 may also include one or more output devices such as, but not limited to, display screen(s), speakers, haptic devices for tactile feedback, and other types of output devices. In certain cases, the input and output devices may be combined in a single device, such as a touchscreen display which both depicts images and receives touch gesture input from the user.

The network interface 540 allows the system to communicate with other computing devices, including server computing devices and other client devices, over a network. The network interface 540 can include a unit to perform the function of transmitting and receiving radio frequency communications to facilitate wireless connectivity between the system and the “outside world,” via a communications carrier or service provider. Transmissions to and from the network interface 540 are conducted under control of the operating system 530, which disseminates communications received by the network interface 540 to application programs 525 and vice versa.

Certain techniques set forth herein may be described in the general context of computer-executable instructions, such as program modules, executed by one or more computing devices. Generally, program modules include routines, programs, objects, components, and data structures that perform particular tasks or implement particular abstract data types.

Embodiments may be implemented as a computer process, a computing system, or as an article of manufacture, such as a computer program product or computer-readable medium. Certain methods and processes described herein can be embodied as code and/or data, which may be stored on one or more computer-readable media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims presented now or in the future.

What is claimed is:

1. A method comprising:
providing a bill detail for a bank-as-biller account within a graphical user interface of a banking application, wherein the bank-as-biller account has a biller identifier for electronic payment to the bank-as-biller account and an open banking identifier associated with the bank-as-biller account;
establishing a connection with the bank-as-biller account using the open banking identifier;
receiving a request to view transaction detail history for the bank-as-biller account; and
in response to the request to view transaction detail history for the bank-as-biller account:
calling a first open banking application programming interface (API) over the established connection with the bank-as-biller account to obtain the transaction detail history for the bank-as-biller account;
receiving the transaction detail history; and
generating a transaction history view using the received transaction detail history.

2. The method of claim 1, wherein the first open banking API gets a specified customer's account transactions associated with a specified bank-as-biller account identified by the open banking identifier.

3. The method of claim 1, further comprising:
receiving a payment request to effect payment for the bank-as-biller account;
performing a first electronic payment using the biller identifier associated with the bank-as-biller account to effect the payment for the bank-as-biller account;
confirming payment to the bank-as-biller account is reflected in a balance for the bank-as-biller account using the established connection with the bank-as-biller account; and
generating a confirmation transaction view for displaying updated account information of the bank-as-biller account that reflects an application of the payment to the bank-as-biller account by the bank-as-biller account.

4. The method of claim 3, wherein confirming the payment to the bank-as-biller account is reflected in the balance for the bank-as-biller account comprises:
calling a second open banking API over the established connection with the bank-as-biller account to obtain updated information including a balance due and an account balance.

5. The method of claim 4, wherein the second open banking API gets updated customer account information comprising the updated information of at least the balance due and the account balance.

6. The method of claim 4, wherein the calling of the second open banking API is performed once each day.

7. The method of claim 1, where establishing the connection with the bank-as-biller account using the open banking identifier comprises:
performing authentication, registration, and connection with a financial institution of the bank-as-biller account using one or more APIs.

8. A computer-readable storage medium having instructions stored thereon that when executed by a computing system direct the computing system to:
provide a bill detail for a bank-as-biller account within a graphical user interface of a banking application, wherein the bank-as-biller account has a biller identifier for electronic payment to the bank-as-biller account and an open banking identifier associated with the bank-as-biller account;
establish a connection with the bank-as-biller account using the open banking identifier;
receive a request to view transaction detail history for the bank-as-biller account; and
in response to the request to view transaction detail history for the bank-as-biller account:
call a first open banking application programming interface (API) over the established connection with the bank-as-biller account to obtain the transaction detail history for the bank-as-biller account;
receive the transaction detail history; and
generate a transaction history view using the received transaction detail history.

9. The computer-readable storage medium of claim 8, wherein the first open banking API gets a specified customer's account transactions associated with a specified bank-as-biller account identified by the open banking identifier.

10. The computer-readable storage medium of claim 8, further comprising instructions to:
receive a payment request to effect payment for the bank-as-biller account;
perform a first electronic payment using the biller identifier associated with the bank-as-biller account to effect the payment for the bank-as-biller account;
confirm payment to the bank-as-biller account is reflected in a balance for the bank-as-biller account using the established connection with the bank-as-biller account; and
generate a confirmation transaction view for displaying updated account information of the bank-as-biller account that reflects an application of the payment to the bank-as-biller account by the bank-as-biller account.

11. The computer-readable storage medium of claim 10, wherein the instructions to confirm the payment to the bank-as-biller account is reflected in the balance for the bank-as-biller account direct the computing system to call a second open banking API over the established connection with the bank-as-biller account to obtain updated information including a balance due and an account balance.

12. The computer-readable storage medium of claim 11, wherein the second open banking API gets updated customer account information comprising the updated information of at least the balance due and the account balance.

13. The computer-readable storage medium of claim 11, wherein the instruction to call the second open banking API is performed once each day.

14. The computer-readable storage medium of claim 8, wherein the instructions to establish the connection with the bank-as-biller account using the open banking identifier direct the computing system to perform authentication, registration, and connection with a financial institution of the bank-as-biller account using one or more APIs.

15. A system, comprising:
a processor; and
a computer-readable storage medium having instructions stored thereon that when executed by the processor direct the system to:
provide a bill detail for a bank-as-biller account within a graphical user interface of a banking application, wherein the bank-as-biller account has a biller identifier for electronic payment to the bank-as-biller account and an open banking identifier associated with the bank-as-biller account;
establish a connection with the bank-as-biller account using the open banking identifier;
receive a request to view transaction detail history for the bank-as-biller account; and
in response to the request to view transaction detail history for the bank-as-biller account:
call a first open banking application programming interface (API) over the established connection with the bank-as-biller account to obtain the transaction detail history for the bank-as-biller account;
receive the transaction detail history; and
generate a transaction history view using the received transaction detail history.

16. The system of claim 15, wherein the first open banking API gets a specified customer's account transactions associated with a specified bank-as-biller account identified by the open banking identifier.

17. The system of claim 15, wherein the instructions further direct the system to:
receive a payment request to effect payment for the bank-as-biller account;
perform a first electronic payment using the biller identifier associated with the bank-as-biller account to effect the payment for the bank-as-biller account;
confirm payment to the bank-as-biller account is reflected in a balance for the bank-as-biller account using the established connection with the bank-as-biller account; and
generate a confirmation transaction view for displaying updated account information of the bank-as-biller account that reflects an application of the payment to the bank-as-biller account by the bank-as-biller account.

18. The system of claim 17, wherein the instructions to confirm the payment to the bank-as-biller account is reflected in the balance for the bank-as-biller account direct the system to call a second open banking API over the established connection with the bank-as-biller account to obtain updated information including a balance due and an account balance.

19. The system of claim 18, wherein the second open banking API gets updated customer account information comprising the updated information of at least the balance due and the account balance.

20. The system of claim 18, wherein the instruction to call the second open banking API is performed once each day.
